(19) United States
(12) Patent Application Publication
(10) Pub. No.: US 2024/0367179 A1
(43) Pub. Date: Nov. 7, 2024

(54) COMPOSITIONS AND METHODS FOR SEPARATING METALS AND/OR MINERALS FROM A SOURCE MATERIAL USING FROTH FLOTATION

(71) Applicant: LOCUS SOLUTIONS IPCO, LLC, SOLON, OH (US)

(72) Inventors: RONNEY SILVA, SOLON, OH (US); GABRIELA KNESEL, SOLON, OH (US); JONATHAN ROGERS, SOLON, OH (US)

(21) Appl. No.: 18/253,957

(22) PCT Filed: Apr. 1, 2023
(86) PCT No.: PCT/US2023/065254

§ 371 Date: May 23, 2023

Related U.S. Application Data
(60) Provisional application No. 63/326,374, filed on Apr. 1, 2022.
(60) Provisional application No. 63/482,319, filed on Jan. 31, 2023.
(60) Provisional application No. 63/489,006, filed on Mar. 8, 2023.

(51) Int. Cl. B03D 1/004; B03D 1/02

(52) U.S. Cl. CPC B03D 1/004; B03D 1/02; B03D 2201/02; B03D 2201/04; B03D 2203/025; B03D 2203/08

(57) ABSTRACT

The subject invention provides safe, environmentally-friendly, compositions and methods for extracting minerals and/or metals from rock, ore, tailings, and/or coal combustion wastes. More specifically, the subject invention provides for enhanced froth flotation, including direct flotation or reverse flotation, of rock, ore, tailings, and/or coal fly ash using a composition comprising one or more biosurfactants.

### CROSS-REFERENCE TO RELATED APPLICATIONS

This application claims priority to U.S. Provisional Patent Applications No. 63/326,374, filed Apr. 1, 2022; No. 63/482,319, filed Jan. 31, 2023; and 63/489,006 filed Mar. 8, 2023, each of which is incorporated herein by reference in its entirety.

### BACKGROUND OF THE INVENTION

“Beneficiation” is a process or series of processes wherein two or more materials that coexist in a mixture (e.g., fine ore powders, fly ash) are separated from each other using chemical and/or mechanical processes. Often, one of the materials (the beneficiary) is more valuable or desired than the other (the gangue). Sometimes, one of the materials is an impurity that is being removed from other more valuable materials.

One form of beneficiation is flotation. Commonly, flotation exploits differences in the hydrophobicity of the respective components. The components are introduced into a flotation apparatus that is sparged with air to form bubbles. The hydrophobic particles preferentially attach to the bubbles, buoying them to the top of the apparatus. The floated particles (the concentrate) are collected, dewatered and accumulated. The less hydrophobic particles (the tailings) tend to migrate to the bottom of the apparatus from where they can be removed.

There are two common forms of flotation separation: direct flotation and reverse flotation. In direct flotation processes, the concentrate is the beneficiary and the tailings are the gangue. In reverse flotation processes, the gangue constituent is floated into the concentrate and the beneficiary remains behind in the slurry. The object of flotation is to separate and recover as much of the valuable constituent(s) as possible in as high a concentration as possible, which is then made available for further downstream processing steps.

Efficiently removing deposits from the earth with various mining and quarrying practices commonly employs flotation methods to purify the targeted elements, minerals, compounds, or other substances. In order to extract the element, mineral or compound of interest, it can be necessary to crush and grind the ore and preconcentrate or separate the element, mineral, or compound of interest from the ore by flotation.

Froth flotation separation can be used to separate solids from solids (such as the constituents of mine ore) or liquids from solids or from other liquids (such as the separation of bitumen from oil sands). When used on solids, froth separation also often includes dry-grinding and/or wet-grinding of the solids, or comminution. This makes the solids more readily dispersible in a froth slurry, liberates some of the beneficiary from the gangue, and the small solid hydrophobic particles can more readily adhere to the sparge bubbles.

There are a number of additives that can be added to increase the efficiency of a froth flotation separation. Collectors are additives that adhere to the surface of concentrate particles and enhance their overall hydrophobicity and preferential attachment to gas bubbles. The remaining tailings that are not modified by the collector remain in the slurry. Examples of collectors include oily products such as fuel oil, tar oil, animal oil, vegetable oil, fatty acids, fatty amines, and hydrophobic polymers. Other additives include frothing agents, promoters, regulators, modifiers, depressors (deactivators) and/or activators, which enhance the selectivity of the flotation step and facilitate the removal of the concentrate from the slurry.

The performance of collectors can be enhanced by the use of modifiers. Modifiers may either increase the adsorption of the collector onto a given mineral (promoters), or prevent collector from adsorbing onto a mineral (depressants). Promoters work by enhancing the dispersion of the collector within the slurry, increase the adhesive force between the concentrate and the bubbles and/or increase the selectivity of what adheres to the bubbles. Depressants can also increase selectivity, but act by increasing the hydrophilic properties of materials selected to remain within the slurry.

Frothing agents, or frothers, are chemicals added to the process that have the ability to change the surface tension of a liquid such that the properties of the sparging bubbles are modified. Frothers may act to stabilize air bubbles so that they will remain well-dispersed in a slurry and will form a stable froth layer that can be removed before the bubbles burst. Ideally, the frother should not enhance the flotation of unwanted material and should have the tendency to break down when removed from a flotation apparatus. Collectors are typically added before frothers, and should not chemically interfere with one other. Commonly used frothers include pine oil, aliphatic alcohols such as MIBC (methyl isobutyl carbinol), polyglycols, polygloycol ethers, polypropylene glycol ethers, polyoxyparafins, cresylic acid (Xylenol), commercially available alcohol blends such as those produced from the production of 2-ethylhexanol and any combination thereof.

In addition to beneficiation processes, flotation can be used to treat fly ash. During combustion of coal in coal-fired systems, the by-products of combustion are entrained in exhaust gases, sometimes referred to as flue gases. These by-products include gaseous compounds such as sulfur dioxide (SO₂), sulfur trioxide (SO₃), hydrochloric acid (HCl), and hydrofluoric acid (HF), and fly ash, which comprises lightweight particulate matter containing oxides of silicon, aluminum iron and calcium, as well as various minerals.

In the past, fly ash was released into the atmosphere as a result of inadequate particulate removal from flue gasses. Now, coal-fired power plants employ methods for capturing fly ash from the flue gas stream using various techniques, including cyclonic separation, flue gas desulfurization units, electrostatic precipitation, and/or bag house filtration, among other techniques. The fly ash is generally stored near the coal power plants in wet or dry impoundments. Alternatively, the fly ash is disposed of in landfills. Some fly ashes are also used as a supplemental cementitious material in concrete mixes.

Accumulations of fly ash in landfills and impoundments can serve as serious environmental hazards. Some fly ashes contain environmental toxins, such as, for example, arsenic, lead, mercury, chromium and cadmium. In the event of a leak, these toxins may leach into soil and ground water. Depending on the source of the coal, some coal fly ashes can also contain valuable minerals that would otherwise be left as waste without further processing, for example, gold, silver, platinum group elements and rare earth metals. Thus, industry would benefit from improved methods for treating fly ash that would reduce the overall amount of fly ash being stored in waste sites, and also take advantage of the valuable components that are present in these otherwise wasted materials.

Froth flotation is a versatile mineral separation method that can be used to separate a variety of economic materials. Unfortunately, many of the current reagents utilized in metal and mineral processing, such as synthetic surfactants and polymers utilized as collectors and frothers, can be harmful to operators and/or the environment with long-term usage. Accordingly, improved materials and methods are needed for recovering valuable minerals and metals using flotation, particularly in the context of rock, ore, tailings, and/or coal fly ash beneficiation.

### BRIEF SUMMARY OF THE INVENTION

The subject invention relates generally to metal and mineral recovery. More specifically, the subject invention provides beneficiation compositions comprising components derived from microorganisms, wherein the compositions are useful for the separation and/or extraction of metals and minerals from rock, ore, tailings, and/or coal combustion waste products. Methods are also provided for separating and/or extracting valuable minerals and/or metals, such as, e.g., gold, silver, platinum, and rare earth metals, from rock, ore, tailings, and/or coal combustion waste products. Advantageously, these compositions and the methods of their use provided herein, are safe, environmentally-friendly, and cost-efficient alternatives to traditional chemical reagents utilized in froth flotation or performance enhancers that can be added to traditional chemical reagents utilized in froth flotation.

In certain preferred embodiments, the subject invention provides a beneficiation composition for use in metal and mineral froth flotation, wherein the composition comprises a microbial culture and/or a microbial growth by-product. In certain embodiments, the microbial growth by-product is a biosurfactant, either in crude form or purified form. The biosurfactant may also be chemically modified. In some embodiments, the composition comprises an aqueous carrier.

In certain embodiments, the composition can be used in methods of direct flotation and reverse flotation. In direct flotation processes, the concentrate is the beneficiary and the tailings are the gangue. In reverse flotation processes, the gangue constituent is floated into the concentrate and the beneficiary remains behind in the slurry. The object of flotation is to separate and recover as much of the valuable constituent(s) as possible in as high a concentration as possible, which is then made available for further downstream processing steps.

In certain embodiments, the composition serves as a collector and/or a frother. In certain embodiments, the composition serves as a performance enhancer or a modifier for traditional collectors and/or frothers.

In certain embodiments the composition comprises a broth in which a microorganism was cultivated, wherein the broth comprises the microbial growth by-product without or without the microorganism. The microorganism may be live, deactivated and/or lysed.

In certain embodiments, the biosurfactant is a glycolipid. In one embodiment, the biosurfactant is a sophorolipid (SLP), including, e.g., linear SLP, lactonic SLP, acetylated SLP, de-acetylated SLP, salt-form SLP derivatives, esterified SLP derivatives, amino acid-SLP conjugates, and other SLP derivatives or isomers that exist in nature and/or are produced synthetically. The composition can also comprise blends of multiple biosurfactants and/or biosurfactant subtypes.

In certain embodiments, the composition further comprises a chemical collector or frother in combination with the biosurfactant or biosurfactant-producing microbial culture. Other additional additives can include, for example, promoters, regulators, modifiers, depressors (deactivators) and/or activators, which enhance the selectivity of the flotation step and facilitate the removal of the concentrate from the slurry.

In preferred embodiments, the subject invention provides methods for separating and/or extracting particles of a target metal or mineral (e.g., the beneficiary) from a particulate source of said target metal, wherein a beneficiation composition of the subject invention is applied to the particles of the source in a froth flotation medium, or slurry. In certain embodiments, the source is a coal combustion waste product, such as, for example, coal fly ash. In certain embodiments, the source is rock, ore, or tailings sourced from a mine or quarry, including, for example, from iron bearing minerals, such as, for example, hematite, goethite, magnetite, martite, or limonite.

In certain embodiments, prior to froth flotation, the methods comprise subjecting the source (e.g., ore, tailings, rock, or fly ash) to roughing or comminution. Roughing or comminution reduces the size and/or size distribution of the source particles and, in some embodiments, liberates some of the target mineral or metal from gangue materials. This can be achieved via, for example, milling, micronizing, pulverizing or otherwise grinding the source particles to particles and/or fines having a desired size. In some embodiments, the desired particle size is between 10 um and 5 mm. In certain embodiments, “fines” have a particle size less than about 3.5 mm.

In certain embodiments, the method comprises applying the source particles and/or fines to water to form a slurry and aerating the slurry in the presence of a beneficiation composition according to the subject invention. In certain embodiments, the composition serves as a collector to facilitate the attachment of air bubbles to particles of the target metal or mineral (e.g., the concentrate), which allows for flotation of the concentrate particles to the surface of the liquid slurry. In alternative embodiments, the composition serves as a collector to facilitate the attachment of air bubbles to particles of gangue, which allows for flotation of the gangue particles to the surface of the liquid slurry. In some embodiments, the method is performed in a tank, vat, column, pool or other vessel.

In certain embodiments, the beneficiation composition serves as a frother to reduce the surface tension of the liquid slurry. In some embodiments, this promotes the even distribution of air bubbles throughout the slurry to enhance adsorption of the concentrate or gangue particles thereto. In some embodiments, the reduced surface tension promotes the formation of a stable froth layer at the surface of the slurry. In some embodiment, a stable froth layer prevents the air bubbles from breaking and dropping the adsorbed concentrate or gangue particles back into the slurry. In certain embodiments, the surface froth layer comprises the concentrate or gangue particles, which can then flow from or be mechanically skimmed from the slurry and collected.

In certain embodiments, the concentrate or gangue particles are detached from the froth bubbles after collection of the froth. The particles can be washed, dried, incinerated, and/or processed by any other means known in the metallurgical arts. Detachment of the particles can be achieved by, for example, applying shear force, such as through the use of an impeller or other mechanical mixer. In certain embodiments, the separated concentrate or gangue particles are dried using, for example, a rotary dryer, a convection dryer, a conveyer, or a fluidized-bed dryer.

The leftover gangue or concentrate materials remaining in the slurry, or tailings, can be collected and re-treated according to the subject methods, if desired, or treated using other beneficiation systems to produce, e.g., concrete-grade ash, copper concentrate, zinc concentrate, iron concentrate, and nickel concentrate.

The biosurfactant-based beneficiation composition can be applied with a traditional chemical collector or frother as a modifier, an adjuvant and/or enhancer for the collector or frother. Advantageously, in certain embodiments, the biosurfactant(s) of the subject composition work in synergy with the collectors and/or frothers to improve their performance. This not only allows for potentially reduced volume usage of harsh chemical reagents, but also enhanced separation yields with reduced time and/or energy expenditure, which can in turn improve the environmental impact of the process.

Thus, in certain embodiments, the subject invention provides methods of enhancing the performance of standard collectors or frothers, wherein the reagents are applied to the froth flotation slurry alongside a biosurfactant and/or a biosurfactant-producing microbial culture according to the subject invention.

In certain embodiments, the target metal or mineral that is recovered from the rock, ore, tailings, and/or coal combustion waste is a valuable compound, such as gold, silver, platinum group metals (platinum, palladium, rhodium, ruthenium, osmium and iridium), and/or rare earth metals (lanthanum, cerium, praseodymium, neodymium, promethium, samarium, europium, gadolinium, terbium, dysprosium, holmium, erbium, thulium, ytterbium, and lutetium). In certain embodiments, the concentration of the target metal or mineral in the concentrate is at least 2% by weight.

In certain embodiments, the coal combustion waste product that serves as the source of the target mineral or metal is fly ash, bottom ash or boiler slag obtained from a coal combustion plant, wherein the coal is anthracite, bituminous, subbituminous and/or lignite coal. In certain specific embodiments, the coal is anthracite coal.

In certain embodiments, the rock, ore, or tailings that serve as the source of the target mineral or metal is obtained from a mine or quarry. In certain embodiments, the mine can be an iron ore mine, copper mine, copper-nickel mine, tin mine, nickel mine, gold mine, silver mine, molybdenum mine, aluminum mine, lead-zinc mine, tungsten mine, zinc mine, ruthenium mine, palladium mine, osmium mine, iridium mine, osmiridium mine, or platinum mine. In certain embodiments, the palladium or nickel mine can be a source of rhodium. The mine can be an underground mine, surface mine, placer mine or in situ mine. In certain embodiments, the quarry can extract chalk, clay, cinder, coal, sand, gravel, coquina, diabase, gabbro, granite, gritstone, gypsum, limestone, marble, ores, phosphate rock, quartz, sandstone, slate, travertine, or any combination thereof.

### BRIEF DESCRIPTION OF THE DRAWINGS

FIG. 1 shows the foaming capabilities of three different biosurfactants using a Design of Experiment (over 55 tests) in which the biosurfactants tested have frother characteristics that can improve flotation (fast froth formation and relatively better stabilization).

FIG. 2 shows the contact angle of particles to bubbles in which the contact angle can be used to correlate the performance in the flotation. The higher the contact angle, the higher the hydrophobicity and flotation recovery.

FIGS. 3A-3C. Pyrite contact angle results show that biosurfactants turns the surface hydrophilic under the entire pH range (FIG. 3A). Possible depressing this mineral during flotation. Hematite contact angle results show a very promising application for a direct flotation; two of the biosurfactants show higher contact angles in the entire pH range (FIG. 3B). The behavior changes remarkably for the chalcopyrite (FIG. 3C); biosurfactant TXS-L-050 makes the sulfide surface more hydrophilic at acidic pH, as seen from a decrease of the contact angle from 82° to 67°. At around pH 5, the surface suddenly becomes hydrophobic, reaching the highest value of 95° at pH 7. As pH is increased further to 12, the contact angle decreases to 88°.

FIG. 4 shows the flotation circuit in the time points at which biosurfactants are added in contract to when amines, sodas, and starches are conventionally added to the flotation process.

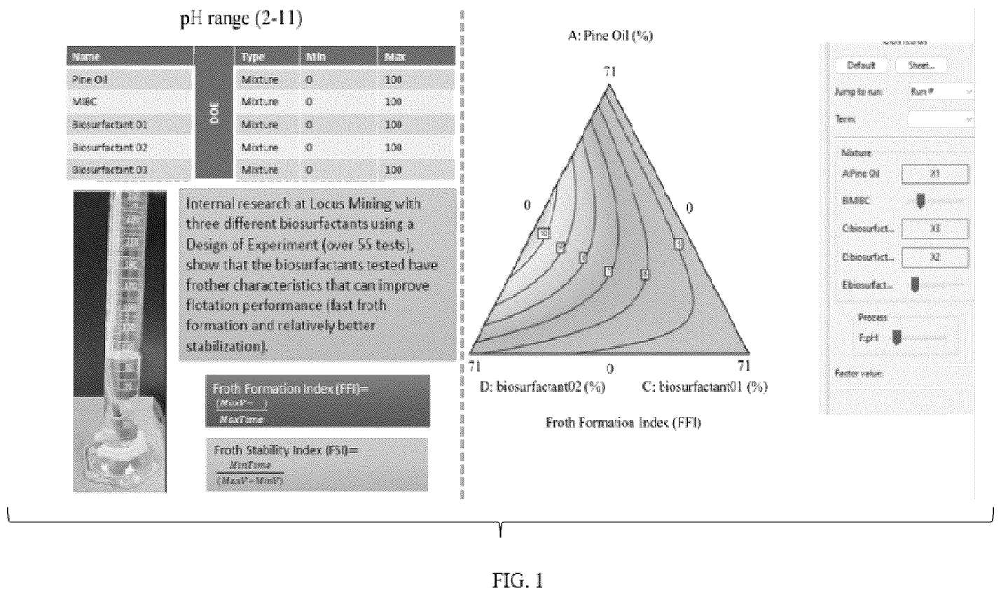

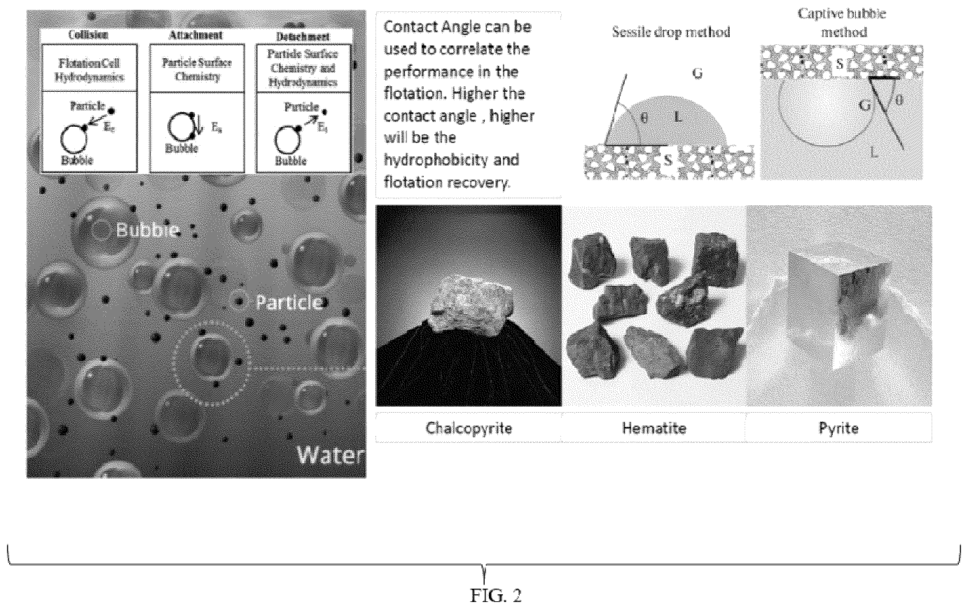

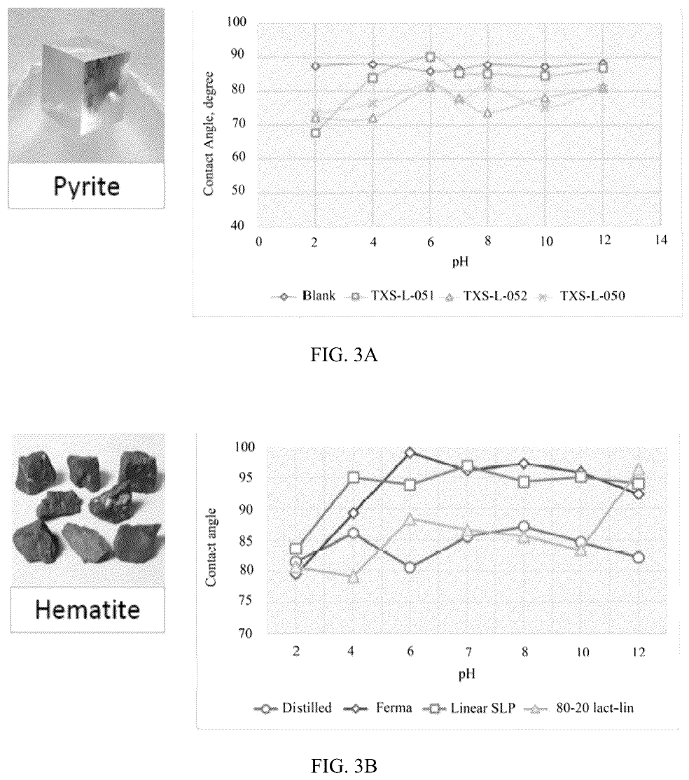

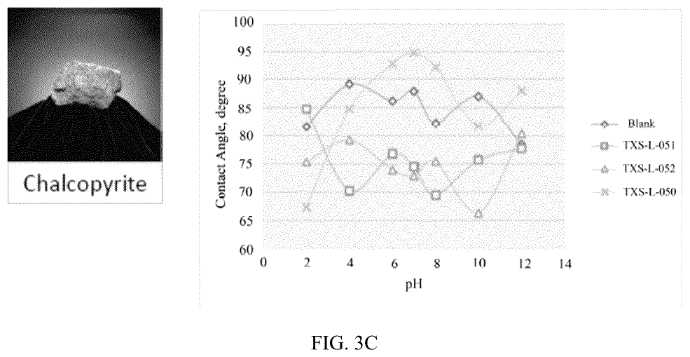

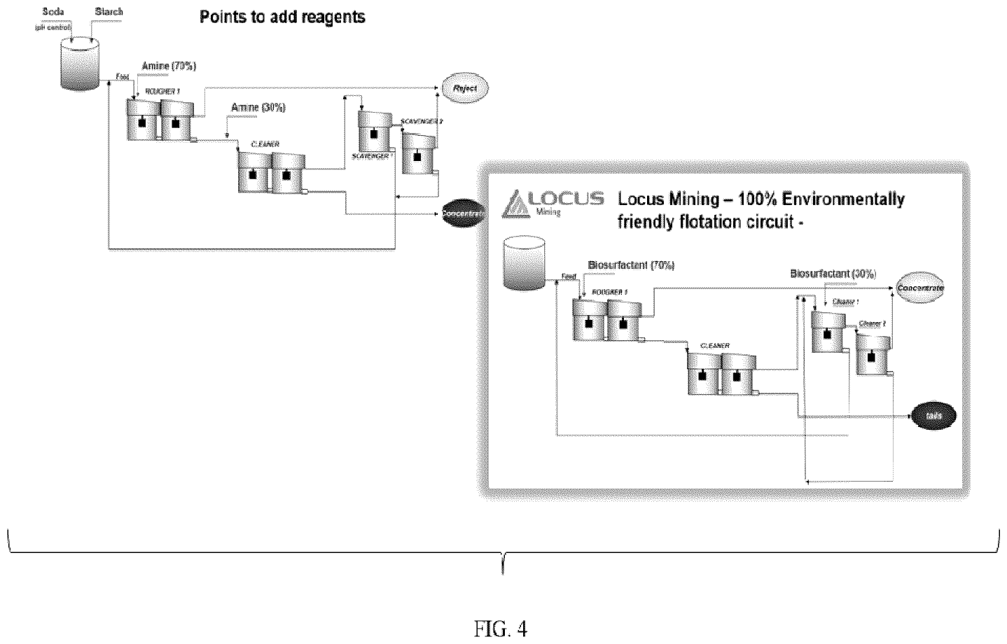

### DETAILED DESCRIPTION

The subject invention provides microbial-derived compositions that are useful for the separation and/or extraction of metals and minerals from rock, ore, tailings, and/or coal combustion waste products. Methods are also provided for separating and/or extracting valuable minerals and/or metals, such as, e.g., iron, gold, silver, platinum, and rare earth metals, from rock, ore, tailings, and/or coal combustion waste products.

Advantageously, the compositions and methods of the subject invention reduce volume usage of harsh and/or toxic flotation reagents, such as collectors and frothers; enhance performance of existing flotation reagents; and reduce energy and time required to produce a desired metal or mineral extraction yield.

### Selected Definitions

As used herein, “applying” a composition or product refers to contacting it with a target or site such that the composition or product can have an effect on that target or site. The effect can be due to, for example, microbial growth and/or the action of a biosurfactant or other microbial growth by-product.

As used herein, “source” in the context of a source of a target metal or mineral refers to a solid material from which a valuable substance, mineral and/or metal can be profitably extracted. Sources can include ores, which are often mined from ore deposits with minerals containing the target mineral or metal. Other “gangue” minerals are minerals containing non-target metals that occur in the source. Examples of ore deposits include hydrothermal deposits, magmatic deposits, laterite deposits, volcanogenic deposits, metamorphically reworked deposits, carbonatite-alkaline igneous related deposits, placer ore deposits, residual ore deposits, sedimentary deposits, sedimentary hydrothermal deposits and astrobleme-related deposits. Sources, as used herein, however, can also include rocks, ore concentrates or tailings, coal or coal combustion waste products, or even other sources of metal or valuable minerals, including but not limited to, jewelry, electronic scraps, batteries and other scrap materials.

As used herein, “slurry” means a mixture comprising a liquid medium within which particles and/or fines of concentrate and tailings are dispersed or suspended, e.g., during froth flotation. The liquid medium may be water, partially water, or may not contain any water at all, and/or can include alcohol, aromatic liquid, phenol, azeotropes, and any combination thereof.

As used herein, “collector” means a composition that selectively adheres to a specific type of particulate substance present in a froth flotation slurry and facilitates the adhesion of the particulate substance to air bubbles that result from aeration of the slurry. In certain embodiments, the particulate substance is hydrophobic in nature. In certain embodiments, the collector increases the hydrophobicity of the particulate substance. Examples of collectors include oily products such as fuel oil, tar oil, animal oil, vegetable oil, fatty acids, fatty acid esters, fatty amines, hydrophobic polymers, neutralized fatty acids, soaps, amine compounds, petroleum-based oily compounds (such as diesel fuels, decant oils, and light cycle oils, kerosene or fuel oils), an organic collector (e.g., xanthates, xanthogen formates, thionocarbamates, dithiophosphates (including sodium, zinc and other salts of dithiophosphates), and mercaptans (including mercaptobenzothiazole), ethyl octylsulfide), and any combination thereof.

As used herein, a “concentrate” means a portion of a source that is separated from a slurry by flotation and collected within the froth layer. By contrast, “tailings” mean a portion of the source that remains in the slurry.

As used herein, a “frother” or “frothing agent” means a composition that reduces the surface tension of liquids, enhance the formation of air bubbles and/or preserve formed air bubbles that are produced by aeration of a froth flotation slurry. Examples of frothers can include but are not limited to aliphatic alcohols, cyclic alcohols, propylene oxide and polypropylene oxide, propylene glycol, polypropylene glycol and polypropylene glycol ethers, polyglycol ethers, polyglycol glycerol ethers, polyoxyparrafins, natural oils such as pine oil an alcohol blend which is from the waste stream of the production of 2-ethyl hexanol and any combination thereof.

As used herein, an “isolated” or “purified” nucleic acid molecule, polynucleotide, polypeptide, protein or organic compound such as a small molecule (e.g., those described below), is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. An isolated microbial strain means that the strain is removed from the environment in which it exists in nature. Thus, the isolated strain may exist as, for example, a biologically pure culture, or as spores (or other forms of the strain) in association with a carrier.

In certain embodiments, purified compounds are at least 60% by weight the compound of interest. Preferably, the preparation is at least 75%, more preferably at least 90%, and most preferably at least 98%, by weight the compound of interest. For example, a purified compound is one that is at least 80%, 85%, 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism or a substance necessary for taking part in a particular metabolic process. A metabolite can be an organic compound that is a starting material, an intermediate in, or an end product of metabolism. Examples of metabolites include, but are not limited to, enzymes, acids, solvents, alcohols, proteins, vitamins, minerals, microelements, amino acids, biopolymers and biosurfactants.

Ranges provided herein are understood to be shorthand for all of the values within the range. For example, a range of 1 to 20 is understood to include any number, combination of numbers, or sub-range from the group consisting 1, 2, 3, 4, 5, 6, 7, 8, 9, 10, 11, 12, 13, 14, 15, 16, 17, 18, 19 and 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein a “reduction” means a negative alteration, and an “increase” means a positive alteration, wherein the negative or positive alteration is at least 0.001%, 0.01%, 0.1%, 0.5%, 1%, 5%, 10%, 15%, 20%, 25%, 30%, 35%, 40%, 45%, 50%, 55%, 60%, 65%, 70%, 75%, 80%, 85%, 90%, 95% or 100%.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of” the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references cited herein are hereby incorporated by reference in their entirety.

### Beneficiation Composition

In certain preferred embodiments, the subject invention provides a beneficiation composition for use in metal and mineral froth flotation, including, for example, direct flotation or reverse floatation.

In certain embodiments, the beneficiation composition comprises a microbe-based product comprising a biosurfactant in crude form. The crude form can comprise, in addition to the biosurfactant, fermentation broth in which a biosurfactant-producing microorganism was cultivated, residual microbial cell matter or live or inactive microbial cells, residual nutrients, and/or other microbial growth by-products. The product may be, for example, at least, by weight, 1%, 5%, 10%, 25%, 50%, 75%, or 100% broth. The amount of biomass in the product, by weight, may be, for example, anywhere from 0% to 100% inclusive of all percentages therebetween.

In some embodiments, the biosurfactant is utilized after being extracted from a fermentation broth and, optionally, purified.

In some embodiments, the beneficiation composition comprises an aqueous solution of a biosurfactant or a blend of biosurfactants. The biosurfactant can be present in the solution from, for example, 1.0% to more than 10% of the composition, or from 0.1% to more than 25% of the composition.

As used herein, “surfactant” means a compound that lowers the surface tension (or interfacial tension) between two liquids or between a liquid and a solid. Surfactants act as, e.g., detergents, wetting agents, emulsifiers, foaming agents, and/or dispersants. A “biosurfactant” is a surface-active substance produced by, and/or derived from, a living cell and/or using naturally derived substrates. Like chemical surfactants, each biosurfactant molecule has its own hydrophobic-lipophilic balance (HLB) value depending on its structure; however, unlike production of chemical surfactants, which results in a single molecule with a single HLB value or range, one cycle of biosurfactant production typically results in a mixture of biosurfactant molecules (e.g., subtypes and isomers thereof).

Biosurfactants are a structurally diverse group of surface-active substances consisting of two parts: a polar (hydrophilic) moiety and non-polar (hydrophobic) group. Due to their amphiphilic structure, biosurfactants can, for example, increase the surface area of hydrophobic water-insoluble substances, increase the water bioavailability of such substances, and change the properties of bacterial cell surfaces. Biosurfactants can also reduce the interfacial tension between water and oil and, therefore, lower the hydrostatic pressure required to move entrapped liquid to overcome the capillary effect. Biosurfactants accumulate at interfaces, thus reducing interfacial tension and leading to the formation of aggregated micellar structures in solution. The formation of micelles provides a physical mechanism to mobilize, for example, oil in a moving aqueous phase. The phrases “biosurfactant” and “biosurfactant molecule” include all forms, analogs, orthologs, isomers, and natural and/or anthropogenic modifications of any biosurfactant class (e.g., glycolipid) and/or subtype thereof (e.g., sophorolipid).

Typically, the hydrophilic group of a biosurfactant is a sugar (e.g., a mono-, di-, or polysaccharide) or a peptide, while the hydrophobic group is typically a fatty acid. Thus, there are countless potential variations of biosurfactant molecules based on, for example, type of sugar, number of sugars, size of peptides, which amino acids are present in the peptides, fatty acid length, saturation of fatty acids, additional acetylation, additional functional groups, esterification, polarity and charge of the molecule.

These variations lead to a group of molecules useful according to the subject methods, comprising a wide variety of classes, including, for example, glycolipids (e.g., sophorolipids, rhamnolipids, cellobiose lipids, mannosylerythritol lipids and trehalose lipids), lipopeptides (e.g., surfactin, iturin, fengycin, arthrofactin and lichenysin), flavolipids, phospholipids (e.g., cardiolipins), fatty acid ester compounds, and high molecular weight polymers such as lipoproteins, lipopolysaccharide-protein complexes, and polysaccharide-protein-fatty acid complexes. Each type of biosurfactant within each class can further comprise subtypes having further modified structures.

In embodiments of the invention, the acid leaching accelerant, bioleaching accelerant, bio-oxidation accelerant, and/or the biosurfactant, is a “sophorolipid,” “sophorolipid molecule,” “SLP” or “SLP molecule” includes all forms, and isomers thereof. The SLP molecule, can be, for example, an acidic (linear) SLP (ASL) and/or a lactonic SLP (LSL). Other SLPs that can be employed, alone, or in addition to an ASL and/or LSL, include a mono-acetylated SLP, di-acetylated SLP, esterified SLP, SLP with varying hydrophobic chain lengths, cationic and/or anionic SLP with fatty acid-amino acid complexes attached, esterified SLP, SLP-salt derivatives (e.g., a sodium salt of a linear SLP), and/or other types of SLPs. These biosurfactants are environmentally friendly.

The ASL and LSL molecules that are employed are, in some embodiments represented by General Formula (1) and/or General Formula (2), below, and are obtained as a collection of 30 or more types of structural homologues having different fatty acid chain lengths (R³), and, in some instances, having an acetylation or protonation at R¹ and/or R².

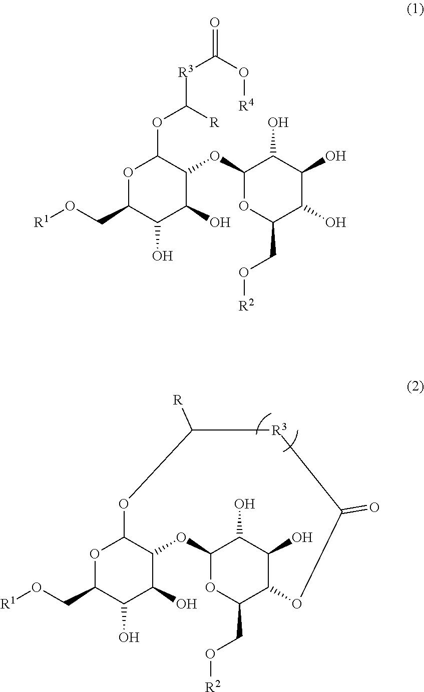

In Formula (1) or (2), R can be either a hydrogen atom or a methyl group. One or both of R¹ and R² are independently a hydrogen atom or an acetyl group. R³ is a saturated, unsaturated, or multiply unsaturated hydrocarbon chain that may have one or more substituents. Independently, substituents at one or more of any carbons of R³ can include halogen, hydroxyl, C₁₋₆ alkyl, halogen substituted C₁₋₆ alkyl, hydroxy substituted C₁₋₆ alkyl, or halogen substituted C₁₋₆ alkoxy groups. R³ typically has 11 to 20 carbon atoms or any subset thereof, for example, 13 to 17 carbon atoms or 14 to 16 carbon atoms. R⁴ can be a hydrogen, an alkali metal, or a C₁₋₆ alkyl group.

SLP are typically produced by yeasts, such as Starmerella spp. yeasts and/or Candida spp. yeasts, e.g., Starmerella (Candida) bombicola, Candida apicola, Candida batistae, Candida floricola, Candida riodocensis, Candida stellate and/or Candida kuoi. SLP have environmental compatibility, high biodegradability, low toxicity, high selectivity and specific activity in a broad range of temperature, pH and salinity conditions. Additionally, in some embodiments, SLP can be advantageous due to their small micelle size, which can help facilitate the movement of the micelle, and compounds enclosed therein, through nanoscale pores and spaces, such as those in source particles. In certain embodiments, the micelle size of a SLP is less than 100 nm, less than 50 nm, less than 20 nm, less than 15 nm, less than 10 nm, or less than 5 nm.

In some embodiments, the biosurfactant can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total beneficiation composition.

In some embodiments, the biosurfactant can be included in the composition at, for example, 0.01 to 100,000 ppm, 0.05 to 10,000 ppm, 0.1 to 1,000 ppm, 0.5 to 750 ppm, 1.0 to 500 ppm, 2.0 to 250 ppm, or 3.0 to 100 ppm, with respect to the amount of source being treated.

In another embodiment, purified biosurfactants may be added in combination with an acceptable carrier, in that the biosurfactant may be presented at concentrations of 0.001 to 50% (v/v), preferably, 0.01 to 20% (v/v), more preferably, 0.02 to 5% (v/v).

In certain specific embodiments, the composition comprises a mixture of ASL and one or more other SLP molecules, such as, for example, LSL. In one embodiment, the percentage of ASL in the composition is about 20% to 50%, or 25% to 30% (with 100% being the sum of the amount of SLP molecules). In one embodiment, the percentage of ASL is over 50% with respect to the total sum of SLP molecules. In another embodiment, the percentage of ASL is over 75%, over 90%, or over 99% with respect to the total sum of SLP molecules.

In order to achieve higher ratios of ASL over the LSL and/or other SLP molecules, the mixture can be subjected to purification via, for example, solvent extraction, alkaline hydrolysis, water washing, oil washing and/or as described in International Patent Publication WO 2021/127339 A1, incorporated herein by reference.

In some embodiments, the composition comprises further components such as cellular matter, broth components, residual feedstock materials (e.g., fatty acids, glucose), and/or additional metabolites from the SLP-producing microorganism that are present at a concentration of, for example, from 50% to 0.001%, from 40% to 1%, or from 25% to 5%, of the total composition volume. In certain embodiments, one or more of these additional components contributes to enhanced activity of the bioleaching composition, compared with the activity of bioleaching compositions comprising higher purity biosurfactant mixtures containing, for example, less than 15%, less than 10%, less than 5%, or less than 1% non-SLP materials and/or components.

In some embodiments, the composition comprises more than one type of biosurfactant, for example, a glycolipid and another glycolipid, or a glycolipid and a lipopeptide.

In certain embodiments, the composition further comprises a chemical collector or frother in combination with the biosurfactant or biosurfactant-producing microbial culture. Other additional additives can include, for example, promoters, regulators, modifiers, depressors (deactivators) and/or activators, which enhance the selectivity of the flotation step and facilitate the removal of the concentrate from the slurry; and/or carriers, other microbe-based compositions, additional biosurfactants or chemical surfactants, leaching reagents (e.g., cyanide, acids, oxidants, microbial leaching agents), enzymes, catalysts, solvents, salts, buffers, chelating agents, emulsifying agents, lubricants, solubility controlling agents, preservatives, stabilizers, ultra-violet light resistant agents, viscosity modifiers, tracking agents, biocides, and other ingredients specific for an intended use.

Methods of Extracting Valuable Minerals and/or Metals from Rocks, Ores, Tailings, and/or Coal Combustion Waste

In certain embodiments, the subject invention provides a method for extracting target minerals and/or metals from a source comprising rock, ore, tailings, and/or coal combustion waste. In certain embodiments, the method generally comprises obtaining the coal combustion waste from, e.g., a coal powerplant, a landfill or an impoundment, said coal combustion waste comprising one or more target minerals and/or metals, in addition to gangue; reducing the particle size of the coal combustion waste; applying a beneficiation composition comprising one or more microorganisms and/or microbial growth by-products, to the particles in a liquid medium; separating the target minerals and/or metals from the gangue using froth flotation; and collecting the target minerals and/or metals. In certain embodiments, the method generally comprises obtaining the ores, ore slurries, rocks, or tailings from, for example, a mine or quarry, said ores, ore slurries, rocks, or tailings comprising one or more target minerals and/or metals, in addition to gangue; reducing the particle size of the ores, ore slurries, rocks, or tailings; applying a beneficiation composition comprising one or more microorganisms and/or microbial growth by-products, to the particles in a liquid medium; separating the target minerals and/or metals from the gangue using froth flotation; and collecting the target minerals and/or metals.

In certain embodiments, the coal combustion waste product that serves as the source of the target mineral or metal is fly ash, bottom ash or boiler slag obtained from a coal combustion plant, a landfill, or a wet or dry impoundment. The coal can be anthracite, bituminous, subbituminous and/or lignite coal. In certain specific embodiments, the coal is anthracite coal.

The subject invention further provides methods for separating and/or extracting particles of a target metal or mineral (e.g., a beneficiary) from a particulate source, wherein a beneficiation composition of the subject invention is applied to the particles in a froth flotation medium, or slurry.

In certain embodiments, prior to froth flotation, the methods comprise subjecting the target-containing source (e.g., fly ash, ore) to roughing or comminution. Roughing or comminution reduces the size and/or size distribution of the ore, rock, tailings, or fly ash particles and, in some embodiments, liberates some of the target mineral or metal from the ore, rock, tailings, or fly ash gangue materials. This can be achieved via, for example, milling, micronizing, pulverizing or otherwise grinding the ore, rock, tailings, or fly ash particles to particles and/or fines having a desired particle size. In some embodiments, the desired particle size is between 10 um and 5 mm.

In certain embodiments, the method comprises applying the ore, rock, tailings, or fly ash particles and/or fines to water to form a slurry and aerating the slurry in the presence of a beneficiation composition according to the subject invention. In some embodiments, aeration is provided via a sparging system.

In certain embodiments, the composition serves as a collector to facilitate the attachment of air bubbles to particles of the target metal or mineral, which allows for flotation of the particles of the targe metal or mineral (e.g., the concentrate) to the surface of the liquid slurry. The method can be performed, for example, in a tank, vat, column, pool or other vessel.

In certain embodiments, the composition serves as a collector to facilitate the attachment of air bubbles to the gangue particles, which allows for flotation of the gangue to the surface of the liquid slurry. The method can be performed, for example, in a tank, vat, column, pool or other vessel.

In certain embodiments, the beneficiation composition serves as a frother to reduce the surface tension of the liquid slurry. In some embodiments, this promotes the even distribution of air bubbles throughout the slurry to enhance adsorption of the concentrate thereto. The reduced surface tension promotes the formation of a stable froth layer at the surface of the slurry, wherein stability prevents the air bubbles from breaking and dropping the adsorbed concentrate particles back into the slurry. In certain embodiments, the surface froth layer comprises the concentrate particles, which can then flow from or be mechanically skimmed from the slurry and collected.

In certain embodiments, the beneficiation composition serves as a frother to reduce the surface tension of the liquid slurry. In some embodiments, this promotes the even distribution of air bubbles throughout the slurry to enhance adsorption of the gangue thereto. The reduced surface tension promotes the formation of a stable froth layer at the surface of the slurry, wherein stability prevents the air bubbles from breaking and dropping the adsorbed gangue particles back into the concentrate. In certain embodiments, the surface froth layer comprises the gangue particles, which can then flow from or be mechanically skimmed from the slurry and removed from the concentrate.

In certain embodiments, the concentrate or gangue particles are detached from the froth bubbles after collection of the froth. The particles can be washed, dried, incinerated, and/or processed by any other means known in the metallurgical arts. Detachment of the particles can be achieved by, for example, applying shear force, such as through the use of an impeller or other mechanical mixer. In certain embodiments, the separated concentrate particles can be dried using, for example, a rotary dryer, a convection dryer, a conveyer, or a fluidized-bed dryer.

In certain embodiments, the composition can be used in methods of direct flotation and reverse flotation. The use of direct floatation of the target mineral or metal or the reverse flotation of the gangue depends on the, for example, chemical makeup, ionic charge, and density of the particles in the slurry. In certain embodiments, the pH of the slurry of the slurry can be modified, including, by, for example, neutralizing the slurry, using the biosurfactant-based beneficiation composition to enhance the effectiveness flotation methods.

In certain embodiments, the pH of the flotation mixture can be about 2 to about 12, about 4 to about 10, about 5 to about 9, or about 6 to about 8. Buffers, and pH regulators, such as carbonates and phosphates, may be used to stabilize pH near a preferred value.

The leftover gangue materials remaining in the slurry, or tailings, can be collected and re-treated according to the subject methods, if desired, or treated using other ash beneficiation systems to produce, e.g., concrete-grade ash.

In certain embodiments, the biosurfactant-based beneficiation composition can be applied with a traditional chemical collector or frother as a modifier, an adjuvant and/or enhancer for the collector or frother. Advantageously, in certain embodiments, the biosurfactant(s) of the subject composition work in synergy with the collectors and/or frothers to improve their performance. This not only allows for potentially reduced volume usage of harsh chemical reagents, but also enhanced separation yields with reduced time and/or energy expenditure, which can in turn improve the environmental impact of the process.

In certain embodiments, the biosurfactant-based beneficiation composition can be applied before, during, and/or after roughing or comminution. In certain embodiments, the biosurfactant-based beneficiation composition can be applied before roughing or comminution instead of a pH adjusting agent (e.g., a soda), a starch, an amine, or any combination thereof. In certain embodiments, the biosurfactant-based beneficiation composition can be applied before roughing or comminution in combination with a pH adjusting agent (e.g., a soda), a starch, an amine, or any combination thereof.

Thus, in certain embodiments, the subject invention provides methods of enhancing the performance of standard collectors or frothers, wherein the reagents are applied to the froth flotation slurry alongside a biosurfactant and/or a biosurfactant-producing microbial culture according to the subject invention.

Advantageously, in one embodiment, the subject methods reduce the amount of refining and processing needed to recover pure or nearly pure metals from rock, ore, tailings, and/or coal combustion waste. The subject method can also be used to reduce the amount of chemical surfactants that are used. Additionally, the present invention can be used without releasing large quantities of inorganic and toxic compounds into the environment. Furthermore, the compositions and methods utilize components that are biodegradable and toxicologically safe, and can be used to reduce the amount of toxic waste produced during metal and mineral extraction, and/or reduce the amount of chemical surfactants that are used.

### Target Metals and Minerals

Examples of target metals that can be extracted using the methods of the subject invention, as well as ores and/or minerals that produce and/or comprise the target metals, include but are not limited to cobalt (e.g., erythrite, skytterudite, cobaltite, carrollite, linnaeite, and asbolite (asbolane)); copper (e.g., chalcopyrite, chalcocite, bornite, djurleite, malachite, azurite, chrysocolla, cuprite, tenorite, native copper and brochantite); gold (e.g., native gold, electrum, tellurides, calaverite, sylvanite and petzite); silver (e.g., sulfide argentite, sulfide acanthite, native silver, sulfosalts, pyrargyrite, proustite, cerargyrite, tetrahedrites); aluminum (e.g, bauxite, gibbsite, bohmeite, diaspore); antimony (e.g., stibnite); barium (e.g., barite, witherite); cesium (e.g., pollucite); chromium (e.g., chromite); cadmium (e.g., sphalerite, greenockite, hawleyite, ramdohrite); iron (e.g., hematite, magnetite, pyrite, pyrrhotite, goethite, siderite); lead (e.g., galena, cerussite, anglesite); lithium (e.g., pegmatite, spodumene, lepidolite, petalite, amblygonite, lithium carbonate); magnesium (e.g., dolomite, magnesite, brucite, carnallite, olivine); manganese (e.g., hausmannite, pyrolusite, barunite, manganite, rhodochrosite); mercury (e.g., cinnabar); molybdenum (e.g., molybdenite); nickel (e.g., pentlandite, pyrrhotite, garnierite); phosphorus (e.g., hydroxylapatite, fluorapatite, chlorapatite); platinum group (platinum, osmium, rhodium, ruthenium, palladium) (e.g., native elements or alloys of platinum group members, sperrylite); potassium (e.g., sylvite, langbeinite); rare earth elements (cerium, dysprosium, erbium, europium, gadolinium, holmium, lanthanium, lutetium, neodymium, praseodymium, samarium, scandium, terbium, thulium, ytterbium, yttrium) (e.g., bastnasite, monazite, loparite); sodium (e.g., halite, soda ash); strontium (e.g., celestite, strontianite); sulfur (e.g., native sulfur, pyrite); tin (e.g., cassiterite); titanium (e.g., scheelite, huebnerite-ferberite); uranium (e.g., uraninite, pitchblende, coffinite, carnotite, autunite); vanadium; zinc (e.g., sphalerite, zinc sulfide, smithsonite, hemimorphite); and zirconium (e.g., zircon).

Additional elements and/or minerals, the extraction of which the subject invention is useful, include, e.g., arsenic, bertrandite, bismuthinite, borax, colemanite, kernite, ulexite, sphalerite, halite, gallium, germanium, hafnium, indium, iodine, columbite, tantalite-columbite, rubidium, quartz, diamonds, garnets (almandine, pyrope and andradite), corundum, barite, calcite, clays, feldspars (e.g., orthoclase, microcline, albite); gemstones (e.g., diamonds, rubies, sapphires, emeralds, aquamarine, kunzite); gypsum; perlite; sodium carbonate; zeolites; chabazite; clinoptilolite; mordenite; wollastonite; vermiculite; talc; pyrophyllite; graphite; kyanite; andalusite; muscovite; phlogopite; menatite; magnetite; dolomite; ilmenite; wolframite; beryllium; tellurium; bismuth; technetium; potash; rock salt; sodium chloride; sodium sulfate; nahcolite; niobium; tantalum and any combination of such substances or compounds containing such substances.

In certain embodiments, the target metal or mineral that is recovered from the rocks, ores, tailings, and/or coal combustion waste is a valuable compound, such as gold, silver, platinum group metals (platinum, palladium, rhodium, ruthenium, osmium and iridium), and/or rare earth metals (lanthanum, cerium, praseodymium, neodymium, promethium, samarium, europium, gadolinium, terbium, dysprosium, holmium, erbium, thulium, ytterbium, and lutetium). In certain embodiments, the concentration of the target metal or mineral in the concentrate is at least 2% by weight.

### Production of Microbe-Based Products

In certain embodiments, the subject invention provides methods for cultivation of microorganisms and production of microbial metabolites and/or other by-products of microbial growth. The subject invention further utilizes cultivation processes that are suitable for cultivation of microorganisms and production of microbial metabolites on a desired scale. These cultivation processes include, but are not limited to, submerged cultivation/fermentation, solid state fermentation (SSF), and modifications, hybrids and/or combinations thereof.

The microorganisms can be, for example, bacteria, yeast and/or fungi. These microorganisms may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In certain embodiments, the microbes are capable of producing amphiphilic molecules, enzymes, proteins and/or biopolymers. Microbial biosurfactants, in particular, are produced by a variety of microorganisms such as bacteria, fungi, and yeasts, including, for example, Agrobacterium spp. (e.g., A. radiobacter); Arthrobacter spp.; Aspergillus spp.; Aureobasidium spp. (e.g., A. pullulans); Azotobacter (e.g., A. vinelandii, A. chroococcum); Azospirillum spp. (e.g., A. brasiliensis); Bacillus spp. (e.g., B. subtilis, B. amyloliquefaciens, B. pumillus, B. cereus, B. licheniformis, B. firmus, B. laterosporus, B. megaterium); Blakeslea; Candida spp. (e.g., C. albicans, C. rugosa, C. tropicalis, C. lipolytica, C. torulopsis); Clostridium (e.g., C. butyricum, C. tyrobutyricum, C. acetobutyricum, and C. beijerinckii); Campylobacter spp.; Corynebacterium spp.; Cryptococcus spp.; Debaryomyces spp. (e.g., D. hansenii); Entomophthora spp.; Flavobacterium spp.; Gordonia spp.; Hansenula spp.; Hanseniaspora spp. (e.g., H. uvarum); Issatchenkia spp; Kluyveromyces spp.; Meyerozyma spp. (e.g., M. guilliermondii); Mortierella spp.; Mycorrhiza spp.; Mycobacterium spp.; Nocardia spp.; Pichia spp. (e.g., P. anomala, P. guilliermondii, P. occidentalis, P. kudriavzevii); Phycomyces spp.; Pythium spp.; Pseudomonas spp. (e.g., P. aeruginosa, P. chlororaphis, P. putida, P. florescens, P. fragi, P. syringae); Pseudozyma spp. (e.g., P. aphidis); Ralstonia spp. (e.g., R. eulropha); Rhodococcus spp. (e.g., R. erythropolis); Rhodospirillum spp. (e.g., R. rubrum); Rhizobium spp.; Rhizopus spp.; Saccharomyces spp. (e.g., S. cerevisiae, S. boulardii sequela, S. torula); Sphingomonas spp. (e.g., S. paucimobilis); Starmerella spp. (e.g., S. bombicola); Thraustochytrium spp.; Torulopsis spp.; Ustilago spp. (e.g., U. maydis); Wickerhamomyces spp. (e.g., W. anomalus); Williopsis spp.; and/or Zygosaccharomyces spp. (e.g., Z. bailii).

In preferred embodiments, microorganism is a Starmerella spp. yeast and/or Candida spp. yeast, e.g., Starmerella (Candida) bombicola, Candida apicola, Candida batistae, Candida floricola, Candida riodocensis, Candida stellate and/or Candida kuoi. In a specific embodiment, the microorganism is Starmerella bombicola, e.g., strain ATCC 22214.

As used herein “fermentation” refers to cultivation or growth of cells under controlled conditions. The growth could be aerobic or anaerobic. In preferred embodiments, the microorganisms are grown using SSF and/or modified versions thereof.

In one embodiment, the subject invention provides materials and methods for the production of biomass (e.g., viable cellular material), extracellular metabolites (e.g. small molecules and excreted proteins), residual nutrients and/or intracellular components (e.g. enzymes and other proteins).

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, humidity, microbial density and/or metabolite concentration.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating technique. Dilution plating is a simple technique used to estimate the number of organisms in a sample. The technique can also provide an index by which different environments or treatments can be compared.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more.

The method can provide oxygenation to the growing culture. One embodiment utilizes slow motion of air to remove low-oxygen containing air and introduce oxygenated air. In the case of submerged fermentation, the oxygenated air may be ambient air supplemented daily through mechanisms including impellers for mechanical agitation of liquid, and air spargers for supplying bubbles of gas to liquid for dissolution of oxygen into the liquid.

The method can further comprise supplementing the cultivation with a carbon source. The carbon source is typically a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as soybean oil, canola oil, madhuca oil, rice bran oil, olive oil, corn oil, sesame oil, and/or linseed oil; etc. These carbon sources may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, sodium chloride, calcium carbonate, and/or sodium carbonate. These inorganic salts may be used independently or in a combination of two or more.

In some embodiments, the method for cultivation may further comprise adding additional acids and/or antimicrobials in the medium before, and/or during the cultivation process. Antimicrobial agents or antibiotics are used for protecting the culture against contamination.

Additionally, antifoaming agents may also be added to prevent the formation and/or accumulation of foam during submerged cultivation.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the medium may be necessary.

The microbes can be grown in planktonic form or as biofilm. In the case of biofilm, the vessel may have within it a substrate upon which the microbes can be grown in a biofilm state. The system may also have, for example, the capacity to apply stimuli (such as shear stress) that encourages and/or improves the biofilm growth characteristics.

In one embodiment, the method for cultivation of microorganisms is carried out at about 5° to about 100° C., preferably, 15 to 60° C., more preferably, 25 to 50° C. In a further embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention further provides a method for producing microbial metabolites such as, for example, biosurfactants, enzymes, proteins, ethanol, lactic acid, beta-glucan, peptides, metabolic intermediates, polyunsaturated fatty acid, and lipids, by cultivating a microbe strain of the subject invention under conditions appropriate for growth and metabolite production; and, optionally, purifying the metabolite. The metabolite content produced by the method can be, for example, at least 20%, 30%, 40%, 50%, 60%, 70%, 80%, or 90%.

The microbial growth by-product produced by microorganisms of interest may be retained in the microorganisms or secreted into the growth medium. The medium may contain compounds that stabilize the activity of microbial growth by-product.

The biomass content of the fermentation medium may be, for example, from 5 g/l to 180 g/l or more, or from 10 g/l to 150 g/l.

The cell concentration may be, for example, at least 1×10⁶ to 1×10¹², 1×10⁷ to 1×10¹¹, 1×10⁸ to 1×10¹⁰, or 1×10⁹ CFU/ml.

The method and equipment for cultivation of microorganisms and production of the microbial by-products can be performed in a batch, a quasi-continuous process, or a continuous process.

In one embodiment, all of the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the fermentation product is removed at any one time. In this embodiment, biomass with viable cells, spores, conidia, hyphae and/or mycelia remains in the vessel as an inoculant for a new cultivation batch. The composition that is removed can be a cell-free medium or contain cells, spores, or other reproductive propagules, and/or a combination of thereof. In this manner, a quasi-continuous system is created.

Advantageously, the method does not require complicated equipment or high energy consumption. The microorganisms of interest can be cultivated at small or large scale on site and utilized, even being still-mixed with their media.

In certain embodiments, the subject invention provides a “microbe-based composition,” meaning a composition that comprises components that were produced as the result of the growth of microorganisms or other cell cultures. Thus, the microbe-based composition may comprise the microbes themselves and/or by-products of microbial growth. The microbes may be in a vegetative state, in spore form, in mycelial form, in any other form of propagule, or a mixture of these. The microbes may be planktonic or in a biofilm form, or a mixture of both. The by-products of growth may be, for example, metabolites, cell membrane components, expressed proteins, and/or other cellular components. The microbes may be intact or lysed. The microbes may be present in or removed from the composition. The microbes can be present, with broth in which they were grown, in the microbe-based composition. The cells may be present at, for example, a concentration of at least 1×10¹, 1×10⁴, 1×10¹, 1×10⁶, 1×10⁷, 1×10¹, 1×10⁹, 1×10¹¹, 1×10¹¹, 1×10¹¹, 1×10¹³ or more CFU per milliliter of the composition.

The subject invention further provides “microbe-based products,” which are products that are to be applied in practice to achieve a desired result. The microbe-based product can be simply a microbe-based composition harvested from the microbe cultivation process. Alternatively, the microbe-based product may comprise further ingredients that have been added. These additional ingredients can include, for example, stabilizers, acids, buffers, carriers, such as water, salt solutions, or any other appropriate carrier, added nutrients to support further microbial growth, non-nutrient growth enhancers, and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

One microbe-based product of the subject invention is simply the fermentation medium containing the microorganisms and/or the microbial metabolites produced by the microorganisms and/or any residual nutrients. The product of fermentation may be used directly without extraction or purification. If desired, extraction and purification can be easily achieved using standard extraction and/or purification methods or techniques described in the literature.

The microorganisms in the microbe-based products may be in an active or inactive form, or in the form of vegetative cells, reproductive spores, conidia, mycelia, hyphae, or any other form of microbial propagule. The microbe-based products may also contain a combination of any of these forms of a microorganism.

In one embodiment, different strains of microbe are grown separately and then mixed together to produce the microbe-based product. The microbes can, optionally, be blended with the medium in which they are grown and dried prior to mixing.

The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

Upon harvesting the microbe-based composition from the growth vessels, further components can be added as the harvested product is placed into containers or otherwise transported for use. The additives can be, for example, buffers, carriers, other microbe-based compositions produced at the same or different facility, viscosity modifiers, preservatives, nutrients for microbe growth, surfactants, emulsifying agents, lubricants, solubility controlling agents, tracking agents, solvents, biocides, antibiotics, pH adjusting agents, chelators, stabilizers, ultra-violet light resistant agents, other microbes and other suitable additives that are customarily used for such preparations.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C. On the other hand, a biosurfactant composition can typically be stored at ambient temperatures.

### Local Production of Microbe-Based Products

In certain embodiments of the subject invention, a microbe growth facility produces fresh, high-density microorganisms and/or microbial growth by-products of interest on a desired scale. The microbe growth facility may be located at or near the site of application. The facility produces high-density microbe-based compositions in batch, quasi-continuous, or continuous cultivation.

The microbe growth facilities of the subject invention can be located at the location where the microbe-based product will be used (e.g., a mine). For example, the microbe growth facility may be less than 300, 250, 200, 150, 100, 75, 50, 25, 15, 10, 5, 3, or 1 mile from the location of use.

Because the microbe-based product can be generated locally, without resort to the microorganism stabilization, preservation, storage and transportation processes of conventional microbial production, a much higher density of microorganisms can be generated, thereby requiring a smaller volume of the microbe-based product for use in the on-site application or which allows much higher density microbial applications where necessary to achieve the desired efficacy. This allows for a scaled-down bioreactor (e.g., smaller fermentation vessel, smaller supplies of starter material, nutrients and pH control agents), which makes the system efficient and can eliminate the need to stabilize cells or separate them from their culture medium. Local generation of the microbe-based product also facilitates the inclusion of the growth medium in the product. The medium can contain agents produced during the fermentation that are particularly well-suited for local use.

Locally-produced high density, robust cultures of microbes are more effective in the field than those that have remained in the supply chain for some time. The microbe-based products of the subject invention are particularly advantageous compared to traditional products wherein cells have been separated from metabolites and nutrients present in the fermentation growth media. Reduced transportation times allow for the production and delivery of fresh batches of microbes and/or their metabolites at the time and volume as required by local demand.

The microbe growth facilities of the subject invention produce fresh, microbe-based compositions, comprising the microbes themselves, microbial metabolites, and/or other components of the medium in which the microbes are grown. If desired, the compositions can have a high density of vegetative cells or propagules, or a mixture of vegetative cells and propagules.

Advantageously, the compositions can be tailored for use at a specified location. In one embodiment, the microbe growth facility is located on, or near, a site where the microbe-based products will be used.

Advantageously, these microbe growth facilities provide a solution to the current problem of relying on far-flung industrial-sized producers whose product quality suffers due to upstream processing delays, supply chain bottlenecks, improper storage, and other contingencies that inhibit the timely delivery and application of, for example, a viable, high cell-count product and the associated medium and metabolites in which the cells are originally grown.

1. A method for extracting a target metal or mineral from particles of a source comprising the target metal or mineral and gangue, the method comprising, applying the source particles to a liquid medium to form a slurry, applying a microbe-based product comprising a biosurfactant to the slurry, and supplying air bubbles to the slurry,
wherein the target metal or mineral separate from the gangue to form a concentrate, wherein the concentrate attaches to the air bubbles and floats to the surface of the slurry, thereby forming a froth layer comprising the concentrate, and wherein the gangue remains in the slurry as tailings.

2. The method of claim 1, wherein the source is coal fly ash.

3. The method of claim 2, wherein the source is coal fly ash is obtained from combustion of anthracite coal.

4. The method of claim 1, wherein the source is a mine or a quarry.

5. The method of claim 4, wherein the mine is a coal mine, iron ore mine, copper mine, copper-nickel mine, tin mine, nickel mine, gold mine, silver mine, molybdenum mine, aluminum mine, lead-zinc mine, tungsten mine, zinc mine, ruthenium mine, palladium mine, osmium mine, iridium mine, osmiridium mine, or platinum mine.

6. The method of claim 4, wherein the quarry contains chalk, clay, cinder, coal, sand, gravel, coquina, diabase, gabbro, granite, gritstone, gypsum, limestone, marble, ores, phosphate rock, quartz, sandstone, slate, travertine, or any combination thereof.

7. The method of claim 1, wherein the target metal or mineral is gold, silver, a platinum group metal, or a rare earth metal.

8. The method of claim 1, wherein the target metal or mineral is iron or an iron-bearing mineral.

9. The method of claim 8, wherein the iron-bearing mineral is hematite, goethite, magnetite, martite, limonite, or any combination thereof.

10-11. (canceled)

12. The method of claim 1, wherein the air bubbles are supplied to the slurry via an air sparging system.

13. The method of claim 1, wherein the microbe-based product comprises, in addition to the biosurfactant, a broth in which a biosurfactant-producing microbe was cultivated, said broth optionally comprising cells and/or cellular matter of the microbe.

14. The method of claim 1, wherein the microbe-based product comprises a purified biosurfactant.

15. The method of claim 1, wherein the microbe-based product comprises a glycolipid biosurfactant, said glycolipid selected from sophorolipids, mannosylerythritol lipids, trehalose lipids and rhamnolipids.

16. The method of claim 15, wherein the glycolipid is a linear sophorolipid or a lactonic sophorolipid.

17. (canceled)

18. The method of claim 1, further comprising applying a frother and/or a collector to the slurry with the microbe-based product.

19. The method of claim 18, wherein the frother is selected from aliphatic alcohols, cyclic alcohols, propylene oxide and polypropylene oxide, propylene glycol, polypropylene glycol and polypropylene glycol ethers, polyglycol ethers, polyglycol glycerol ethers, polyoxyparrafins, natural oils such as pine oil an alcohol blend which is from the waste stream of the production of 2-ethyl hexanol and any combination thereof.

20. The method of claim 18, wherein the collector is selected from as fuel oil, tar oil, animal oil, vegetable oil, fatty acids, fatty acid esters, fatty amines, hydrophobic polymers, neutralized fatty acids, soaps, amine compounds, petroleum-based oily compounds (such as diesel fuels, decant oils, and light cycle oils, kerosene or fuel oils), an organic collector (e.g., xanthates, xanthogen formates, thionocarbamates, dithiophosphates (including sodium, zinc and other salts of dithiophosphates), and mercaptans (including mercaptobenzothiazole), ethyl octylsulfide), and any combination thereof.

21. The method of claim 1, wherein the microbe-based product serves as a frother or a collector.

22. The method of claim 1, further comprising separating the concentrate from the froth layer using mechanical force.

23. The method of claim 22, further comprising drying the concentrate to obtain the target metal or mineral.

24. A method for extracting a target metal or mineral from particles of a source comprising the target metal or mineral and gangue, the method comprising, applying the source particles to a liquid medium to form a slurry, applying a microbe-based product comprising a biosurfactant to the slurry, and supplying air bubbles to the slurry,
wherein the target metal or mineral separate from the gangue to form a concentrate, wherein the gangue attaches to the air bubbles and floats to the surface of the slurry, thereby forming a froth layer comprising the gangue, and wherein the concentrate remains in the slurry as tailings.

25. The method of claim 24, wherein the source is coal fly ash.

26. The method of claim 25, wherein the source coal fly ash is obtained from combustion of anthracite coal.

27. The method of claim 24, wherein the source is a mine or a quarry.

28. The method of claim 27, wherein the mine is a coal mine, iron ore mine, copper mine, copper-nickel mine, tin mine, nickel mine, gold mine, silver mine, molybdenum mine, aluminum mine, lead-zinc mine, tungsten mine, zinc mine, ruthenium mine, palladium mine, osmium mine, iridium mine, osmiridium mine, or platinum mine.

29. The method of claim 27, wherein the quarry contains chalk, clay, cinder, coal, sand, gravel, coquina, diabase, gabbro, granite, gritstone, gypsum, limestone, marble, ores, phosphate rock, quartz, sandstone, slate, travertine, or any combination thereof.

30. The method of claim 24, wherein the target metal or mineral is gold, silver, a platinum group metal, or a rare earth metal.

31. The method of claim 24, wherein the target metal or mineral is iron or an iron-bearing mineral.

32. The method of claim 31, wherein the iron-bearing mineral is hematite, goethite, magnetite, martite, limonite, or any combination thereof.

33-34. (canceled)

35. The method of claim 24, wherein the air bubbles are supplied to the slurry via an air sparging system.

36. The method of claim 24, wherein the microbe-based product comprises, in addition to the biosurfactant, a broth in which a biosurfactant-producing microbe was cultivated, said broth optionally comprising cells and/or cellular matter of the microbe.

37. The method of claim 24, wherein the microbe-based product comprises a purified biosurfactant.

38. The method of claim 24, wherein the microbe-based product comprises a glycolipid biosurfactant, said glycolipid selected from sophorolipids, mannosylerythritol lipids, trehalose lipids and rhamnolipids.

39. The method of claim 38, wherein the glycolipid is a linear sophorolipid or a lactonic sophorolipid.

40. (canceled)

41. The method of claim 24, further comprising applying a frother and/or a collector to the slurry with the microbe-based product.

42. The method of claim 41, wherein the frother is selected from aliphatic alcohols, cyclic alcohols, propylene oxide and polypropylene oxide, propylene glycol, polypropylene glycol and polypropylene glycol ethers, polyglycol ethers, polyglycol glycerol ethers, polyoxyparrafins, natural oils such as pine oil an alcohol blend which is from the waste stream of the production of 2-ethyl hexanol and any combination thereof.

43. The method of claim 41, wherein the collector is selected from as fuel oil, tar oil, animal oil, vegetable oil, fatty acids, fatty acid esters, fatty amines, hydrophobic polymers, neutralized fatty acids, soaps, amine compounds, petroleum-based oily compounds (such as diesel fuels, decant oils, and light cycle oils, kerosene or fuel oils), an organic collector (e.g., xanthates, xanthogen formates, thionocarbamates, dithiophosphates (including sodium, zinc and other salts of dithiophosphates), and mercaptans (including mercaptobenzothiazole), ethyl octylsulfide), and any combination thereof.

44. The method of claim 24, wherein the microbe-based product serves as a frother or a collector.

45. The method of claim 24, further comprising separating the gangue from the froth layer using mechanical force.

46. The method of claim 45, further comprising drying the concentrate to obtain the target metal or mineral.
